(19) United States
(12) Patent Application Publication
(10) Pub. No.: US 2016/0277052 A1
(43) Pub. Date: Sep. 22, 2016

(54) Modular Portable Power Device

(71) Applicant: Kerloss Sadek, Corona, CA (US)

(72) Inventor: Kerloss Sadek, Corona, CA (US)

(21) Appl. No.: 14/664,823

(22) Filed: Mar. 21, 2015

Related U.S. Application Data
(60) Provisional application No. 62/135,191, filed on Mar. 19, 2015.

(51) Int. Cl. H04B 1/3888; H04M 1/02

(52) U.S. Cl. CPC H04B 1/3888; H04M 1/0202

(57) ABSTRACT

Embodiments include modular expansion kits for mobile devices including functional elements such as function-specific configurations that pair with an expansion platform providing supplemental power, memory, and processing to create a flexible and inexpensive accessory.

### CROSS-REFERENCE TO RELATED APPLICATIONS

This application claims the benefit under 35 U.S.C. §119(e) of U.S. Provisional Patent Application No. 62/135,191, filed on Mar. 19, 2015, and titled “Modular Portable Power Device.” The above provisional patent application is incorporated by reference in its entirety and made a part of this specification.

### FIELD OF THE INVENTION

The present invention relates generally to accessories for mobile devices. More particularly embodiments include a modular protective case expansion kit for mobile electronics.

### DESCRIPTION OF THE RELATED ART

Today's mobile devices (e.g., cellular phones, music players, digital cameras, point-of-view cameras, wearable computers, smart watches, mobile hot spots. and mobile computers) depend on electrical charge stored in batteries to allow users to rely on the device throughout the day. As device screens increase in size, resolution, and refresh rate, they consume more power, Similarly, as devices integrate more powerful processors and broadening feature sets, the devices consume power at ever-increasing rates. The charge capacity per volume of batteries has not kept pace with the power consumption of devices. Users are frequently forced to either limit their device use during the day or recharge their devices mid-day, and that problem is exacerbated if a user is not near a potential charging location. Either of these uses restricts an otherwise powerful and flexible mobile device.

While mobile battery pack solutions exist, they often come in bulky form-factors that detract from the sleek aesthetic of modern high-end mobile devices.

In order to address the above-described exemplary problems, and other similar problems, a novel case protection platform is needed to increase freedom and convenience for mobile device users without adding unnecessary bulk.

### BRIEF DESCRIPTION OF THE DRAWINGS

FIG. 1 shows an example embodiment of a mobile device, a shell, a first outer case portion, a second outer case portion, and an expansion platform in a decoupled position.

FIG. 2 shows a rear view of the example mobile device, shell, first outer case portion, second outer case portion, and expansion platform in a decoupled position.

FIG. 3 shows an example embodiment of a first outer case portion, a second outer case portion, and an expansion platform in a coupled position to form a case.

FIG. 4 shows a rear view of the example first outer case portion, second outer case portion, and expansion platform in a coupled position to form a case.

FIG. 5 shows an example embodiment of a first outer case portion and second outer case portion in a coupled position.

FIG. 6 shows a rear view of an example embodiment of a first outer case portion and second outer case portion in a coupled position containing a shell.

FIG. 7 shows an example embodiment of a top gaming portion, a bottom gaming portion, and an expansion platform in a coupled position to form a gaming expansion.

FIG. 8 shows an example embodiment of a top speaker portion, a bottom speaker portion, and an expansion platform in a coupled position to form a speaker expansion.

FIG. 9 shows an example embodiment of a top point-of-view mount portion, a bottom point-of-view mount portion, and an expansion platform in a coupled position to form a point-of-view mount expansion.

FIG. 10 shows an example embodiment of a universal battery bank portion without the expansion platform.

### DETAILED DESCRIPTION

Various embodiments disclosed herein relate to a modular battery case for a mobile device. The battery element can be separated from the case, and can be adjusted to be as simple as a thin shell or as complex as a gaming-specific case. The modular elements allow for a user to have a flexible case solution that is functional for many situations without paying for redundant electronics. Over time, smartphones have improved to perform the tasks recently performed by music players, GPS (global positioning satellite) units, PDAs (personal digital assistants), and digital cameras, which reduces the number of devices that a a user must carry, without any loss of functionality.

Additionally many consumer electronics include similar core elements, such as a battery, a processor, a storage memory, and a display. If these core elements were included in a single expansion platform, minor peripheral adjustments to sensors or input could quickly and inexpensively adjust functionality. This core expansion platform, in combination with a pre-existing mobile device, can significantly increase convenience while reducing the cost and waste associated with redundant consumer electronics.

Further, a single expansion platform could function across multiple mobile devices (e.g., an iPhone™ from Apple, a Galaxy S6® or Galaxy Note 4® from Samsung) with only minor input and case adjustments. By making a single expansion platform that functions with multiple mobile devices, a manufacturer or retailer can significantly reduce the necessary on-hand inventory for expensive functional pieces. Additionally generational device changes, such as the change between the Samsung Galaxy Note 3® and the Samsung Galaxy Note 4® would not require complete peripheral replacement. Similarly a user could use a single expansion platform across multiple devices, for example if a user had an iPhone™ for personal use and a Blackberry® for business use.

In the following detailed description, numerous specific details are set forth in order to provide a thorough understanding of the invention. However, the invention may be practiced without these specific details. In other instances, well known methods, procedures, and/or components have not been described in detail so as not to unnecessarily obscure aspects of the invention.

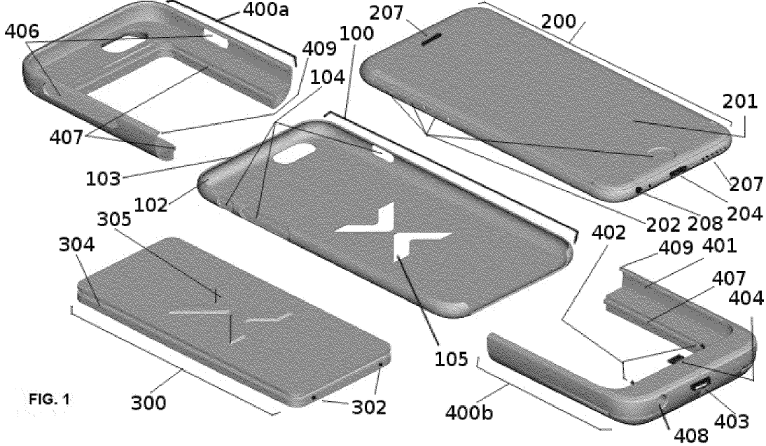

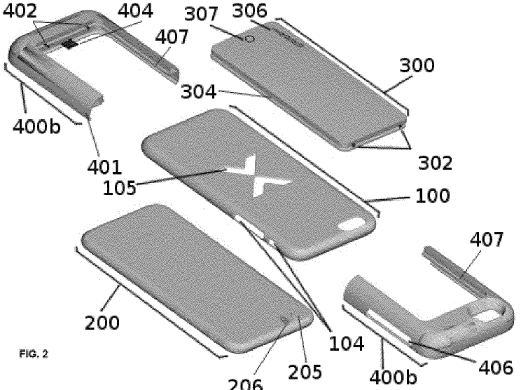

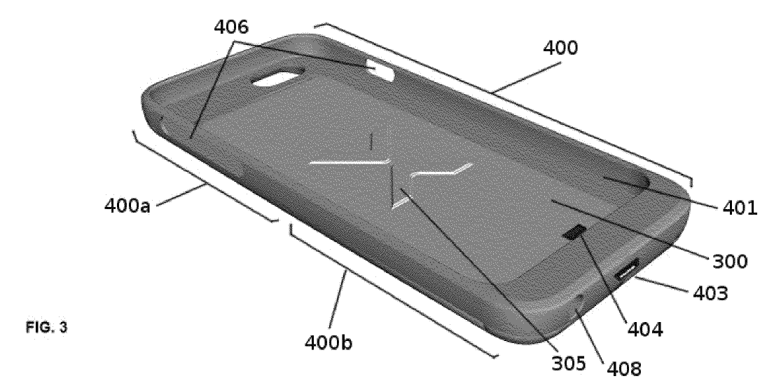

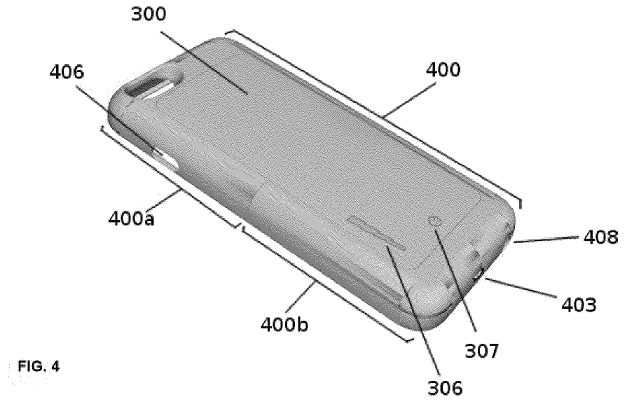

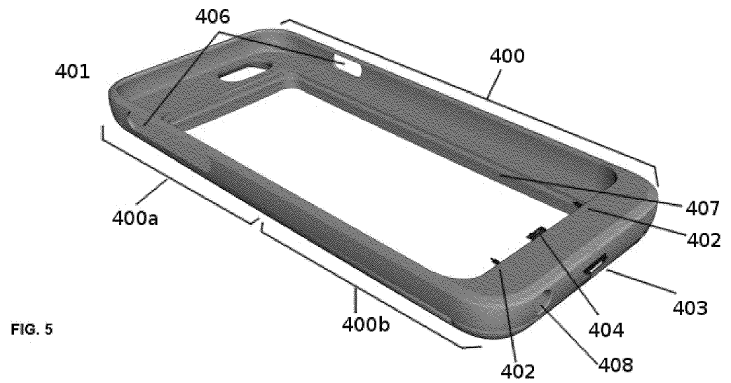

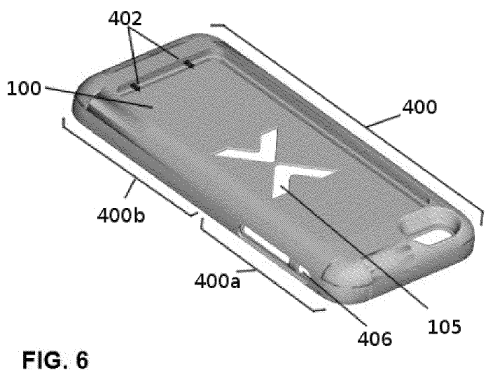

FIG. 1 through FIG. 4 show front and rear perspective views of a mobile device 200 along with a modular expansion kit comprising inner shell 100, a mobile device 200, an expansion platform 300, a first outer case portion 400a, and a second outer case portion 400b. In FIG. 1 and FIG. 2 the elements are all decoupled, while FIG. 3 and FIG. 4 show the same elements excluding mobile device 200 in a coupled arrangement. FIG. 5 shows only first outer case portion 400a and second outer case portion 400b in a coupled position. FIG. 6 shows mobile expansion platform 300 coupled to first outer case portion 400a and second outer case portion 400b.

For illustrative purposes, mobile device 200 is depicted as an iPhone™ by Apple, Inc. Mobile device 200 includes a device screen or device touchscreen 201, a number of device buttons or device switches 202, a general-use device processor 203, and at least one device interface 204. Mobile device 200 may optionally include a device camera lens 205, a device flash 206, a device speaker 207, and a device microphone 208.

A user may secure mobile device 200 inside shell 100, then connect expansion platform 300 to shell 100, and enclose this combination in outer case 400. Alternatively the present invention can be used in any combination of shell 100, expansion platform 300, and outer case 400. A user may choose to use his device with only shell 100 for protection without bulk. User may also elect to use expansion platform 300 and outer case 400 without shell 100.

Inner shell 100 can be form-factor specific and is ideally made of a thin, durable material (e.g., carbon fiber, plastic, silicon or rubber) that can fit securely around the case and provide protection to mobile device 200. Shell 100 may be a rigid protective mobile device case that is form-factor specific; however, two embodiments of shell 100 that would not be form-factor specific would be if the material were pliable and stretchable (e.g., rubber or elastic) so that the case could be stretched to wrap around the corners of different mobile devices 200 or if shell 100 were made of fabric and included a drawstring to restrict shell 100 around mobile device 200.

Inner shell 100 is shaped to receive mobile device 200 within a contoured cavity 101, which is surrounded by a sidewall 102. Sidewall 102 can extend to include a lip 103 that extends beyond the front surface of the mobile device to shield device screen 201 in case of a drop or bump, In some embodiments, lip 103 can wrap around the front of mobile device 200 to secure mobile device 200 within contoured cavity 101, though Lip 103 should not cover any portion of device screen 201. Inner shell 100 also includes openings 104 to allow unimpeded use of buttons or switches, lens, flash, speakers, or microphones on mobile device 200. Inner shell 100 also includes a first attachment point 105 that pairs with attachment tongue 305 on expansion platform 300.

In one embodiment, attachment point is actually a cut-out through inner shell 100 that allows mobile device 200 to dissipate heat without sacrificing protection. Additionally attachment tongue 305 may extend through attachment point 145 to make contact with mobile device 200. In other embodiments, the mechanical coupling between attachment point 105 and attachment tongue 305 can be made of any arrangement for securing two pieces (e.g., tongue-and-groove, rotating lock, sliding lock, hook and notch, button and snap, hooked loop fastener, adhesive, magnetic pairing, or any other mechanical coupling arrangement).

In one embodiment, expansion platform 300 does not have to directly mechanically or electrically couple to mobile device 200. Because expansion platform 300 does not connect directly to mobile device 200, expansion platform does not need to match the mobile device electrical interface 204 or the dimensions of mobile device 200, which means that expansion platform 300 may be device agnostic. Expansion platform 300 can be used with many different mobile devices, so long as coupled to appropriate device-specific shell 100 and device-specific outer case 400. Although shell 100 and outer case 400 may require customization for different mobile device form factors, expansion platform 300 can work with any of the shells 100 or outer cases 400. Expansion platform may be customized for a specific mobile device 200, but it need not be.

In the present embodiment, expansion platform 300 is a central module that can mechanically couple to shell 100 with attachment tongue 305. Attachment tongue 305 extends through attachment point 105 to minimize relative motion between shell 100 and expansion platform 300. Attachment tongue 305 may also make physical contact with mobile device 200 through shell 100, which could provide rear pressure to securely hold mobile device 200 within shell 100. Attachment tongue 305 may also be made of a heat-dissipating material capable of rapidly absorbing and releasing excess heat through contact with mobile device 200. Expansion platform 300 also has groove 304 for coupling to rail 407 of outer case 400. Groove 304 may include notches or ratchet so that rail 407 catches inside groove 304. In other embodiments, groove 304 and rail 407 pairing between expansion platform 300 and outer case 400 can be replaced by any other arrangement for securing two pieces (e.g., tongue-and-groove, hook and notch, button and snap, hooked loop fastener, adhesive, magnetic pairing, or any other mechanical coupling arrangement).

Expansion platform 300 includes functional electronic elements 310, an expansion charge indicator 306, and an expansion input 307. Functional electronic element 310 may include various core electronics including an expansion battery 311, an expansion processor 312, an expansion memory 313, an expansion wireless communication chip and antenna 314, or other options that will be discussed in later embodiments. Expansion charge indicator 306 indicates the charge level of expansion battery 311 in response to activation of expansion input 307. Expansion input can be a button, trigger, switch, touch-sensor, a software command, or a sensor for a tap, shake, or voice command. Expansion charge indicator 306 may be any type of output such as a screen, a light, an LED (light emitting diode), an audio alert, or any type of haptic feedback. If expansion charge indicator 306 is based on illumination, the charge level may be indicated by color, dimness, or quantity of lights illuminated. For example, a 25% charge indication could be indicated by illuminating only 1 of 4 LEDs. In some cases, a light pipe would be necessary to transmit light from the internal circuit to the outside of the case without allowing damage to the internal circuit.

Expansion battery 311 is used to power the other functional electronic elements 310 as well as any other elements in the modular protective case expansion kit. Expansion battery 311 can also provide power to mobile device 200—through direct wired connection or through wireless charging—or be used by external devices as discussed later. Although we use the word battery here, it is to be understood that expansion battery 311 could be any energy storage element, including capacitors, super-capacitors, capacitor/battery combinations, and chemical batteries.

Expansion processor 312 may be any type of specific-use or general-use processor, but may handle responsibilities including power management, data management, heat management, safety precautions, security handshakes, charge-level calculation, wireless communication, peripheral sensor control, mathematical calculation, external communication, and device communication. Expansion processor 312 may also be a combination of multiple physical processors or one or many multi-core processors. Elements may also be included to help with heat dissipation such as a heat sync or a fan.

Expansion memory 313 can be used locally within the modular protective case expansion kit, but it may also be used as back-up storage for mobile device 200 or for an external computer. Expansion memory 313 may also be encrypted for security or may only be externally visible to a pre-paired mobile device 200.

Expansion wireless communication chip and antenna 314 may communicate on the same or different frequencies as mobile device 200. In different scenarios, it may be useful for expansion platform 300 to communicate either independently or parasitically through mobile device 200. For example, Expansion wireless communication chip and antenna 314 may include NFC (near field communication)—which is popular in gift cards, wifi pairing, public access points, smartposters, wearable devices, and shipping labels—which is included in the Samsung Galaxy Note® but not in the iPhone™. Other communications that may be used include bluetooth, bluetooth low energy (BLE), wifi, infrared, or cellular network.

Although many embodiments discuss wired communication between mobile device 200 and modular protective case expansion kit, that wired connection may be replaced by wireless communication through expansion wireless communication chip and antenna 314. Bluetooth low energy (BLE) is a low power and effective way to send short commands between mobile device 200 and expansion kit 300. Although mobile device 200 may also be connected to modular protective case expansion kit through device interface 204 for power, any data transmission could involve either wired or wireless communication.

Functional electronic element 310 connects to power and peripherals through expansion interface 302. Expansion interface 302 is capable of transmitting both power and data into and out of functional electronic element 310. Expansion interface 302 can be one or many male POGO pins, female POGO receptors, standard connector types (e.g., USB-A, micro-USB, USB type-C, serial, lightning, SATA, etc.), or any other means for temporarily electrically pairing the expansion platform 300 to a first outer case interface 402. In one embodiment, first outer case interface 402 comprises a number of male POGO pins and expansion interface 302 comprises a number of female pads designed to receive the male POGO pins. In FIG. 1, a pair of expansion interfaces 302 are arranged on the bottom edge of the expansion platform 300. However, in other embodiments, there could be multiple expansion interfaces 302 on various surfaces of expansion platform 300. In one embodiment, expansion interfaces 302 exist on both the top and bottom of expansion platform 300, so that expansion platform could separately provide power out of each side of the expansion platform 300. In another embodiment, there could be at least 4 expansion interfaces 302 with positive interfaces and negative (ground) interfaces alternating at each corner (e.g., top-left positive, top-right negative, bottom-right positive, bottom-left negative). By alternating charge, a circuit can be complete between any 2 adjacent corners. A powered expansion could create a circuit as long as it paired with both expansion interfaces 302 on any of the 4 edges (top, left, bottom, or right).

In some embodiments, outer case 400 may be a durable shell capable of containing mobile device 200. Outer case 400 can resemble a simple outer case that approximates the outer dimensions of mobile device 200 while providing protection. In other embodiments, outer case 400 may be designed to accommodate a specific function, such as a speaker kit, a protective action-camera housing, a gaming controller, or a universal remote control.

In one embodiment, outer case 400 includes outer sidewalls 401 to protect the edges of mobile device 200, but outer case 400 does not have to include a back wall. Outer sidewall 401 may end in a lip 409 to further protect mobile device 200 and device touchscreen 201. Instead outer case 400 surrounds mobile device 400 on all 4 edges (or narrow sides) without blocking the front of back of mobile device 200. Although FIG. 1 shows an outer case 400 surrounding the mobile device on 4 sides, outer case 400 may also be generally U-shaped and protect 3 edges (or narrow sides) of mobile device 200. Outer case 400 could also cover 5 sides of mobile device 200, including rear wall protection, enclosing expansion platform 300. Expansion platform 300 can couple to outer case 400, and when expansion platform 300 is coupled to outer case 200, expansion platform 300 acts as a back wall, blocking and protecting the back of mobile device 200. Outer case 400 includes openings 406, through which elements of mobile device 200 can be accessed. Outer case 400 may also include case headphone channel 408.

Outer case 400 may be a single piece capable of containing expansion platform 300 and shell 100. From FIG. 1, it can be appreciated that outer case 400 may also split into first outer case portion 400a and second outer case portion 400b. Although FIG. 1 depicts this split as occurring in roughly the middle of outer case 400, the split may occur at any point along the outer-case. First outer case portion 400a and second outer case potion 400b may couple together through any known mechanical coupling method. First outer case portion 400a and second outer case potion 400b may couple together without any other elements or first outer case portion 400a and second outer case potion 400b may couple together to enclose mobile device 200 (either with or without shell 100) and expansion platform 300. Expansion platform 300 and outer case 400 could still protect and connect to mobile device 200 without shell 100.

Outer case 400 includes first outer case interface 402, a second outer case interface 403, and a third outer case interface 404. First outer case interface 402 couples with expansion interface 302 as discussed above. Second outer case interface 403 may pair with an external connection (e.g., micro-USB, USB Type-C, apple connector, serial, lightning, mini-stereo, etc.) to transmit electricity or data from outside of the modular protective case expansion kit to the modular protective case expansion kit and to the mobile device. Third outer case interface 404 couples with mobile device electrical interface 204 to enable communication between mobile device 200 and outer case 400.

When all three outer case interfaces (402, 403, 404) are coupled to their respective connections, electricity from second outer case interface 403 can travel through third outer case interface to charge the mobile device battery and through first outer case interface to charge expansion battery 311. Similarly, data from second outer case interface 403 can travel through third outer case interface to communicate with mobile device processor and through first outer case interface to communicate with any of functional electronic elements 310. The system may be configured to charge mobile device battery and expansion battery simultaneously, or to charge either battery before the other.

In one embodiments, the combination of outer case 400, shell 100, and expansion platform 300 would protect a mobile device 200 on 5 sides, leaving only the front, including the mobile device screen and any front buttons uncovered. As one example, shell 100 might cover the top, left, right, and back of mobile device 200. Expansion platform 300 may cover the back of mobile device 200, and outer case 400 may cover the left, right, top, and bottom of mobile device 200. Even though 5 surfaces are covered, there may be intentional holes through the modular protective case expansion kit to allow access to buttons on the mobile device or to avoid impairing the function of the mobile device camera, mobile device speaker, or mobile device microphone.

Although the present embodiments describe functional electronic elements 310 contained in expansion platform 300, functional electronic elements 310 or even redundant elements could also easily be included in outer case 400 or shell 100.

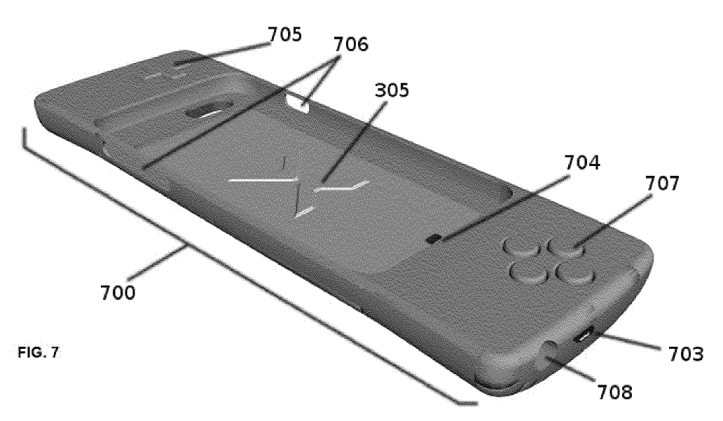

FIG. 7 illustrates the modular protective case expansion kit in a gaming controller configuration. The gaming controller configuration can use the same shell 100 and expansion platform 300, but in this embodiment, outer case 400 is replaced with a gaming controller case 700 specially configured to improve mobile video gaming enjoyment and control.

Mobile video gaming is the fastest growing portion of the video game industry, and unlike traditional console and PC gaming, mobile gaming appeals across gender and generational gaps. The gaming controller case 700 of FIG. 7 allows for improved control for video gaming. Many console and PC video garners have grown familiar with the standard game controller configuration that includes left and right top bumpers 701, a directional-pad 702 (a plus-sign-shaped button that can sense depression in any of 8 directions) accessed by the left thumb and a 4 buttons diamond configuration 707 accessed by the right thumb. Depending if the garner comes from an XBOX® or Playstation® background, 4 button diamond configuration 707 may be traditionally recognized as X, Y, B, and A or square, triangle, circle, and X. There may also be haptic (shake) feedback and additional buttons built into the gaming controller case 700. This controller configuration is used in many consoles and games, and the gaming controller case 700 of the modular protective case expansion kit could be used either for mobile device games played on mobile device 200 or external games played on an external console. Gaming controller case 700 can pair with an external console through a wired or wireless connection. For some consoles, an additional wireless antenna may be required inside of gaming controller case 700 to properly pair. Some consoles allow a mobile device 200 to operate as a “second screen”, displaying additional information about a video game or movie, such as a level map or an inventory display. Using the gaming controller case 700 along with a “second screen” mobile device 200 could enable more in-depth video gaming. Gaming controller case 700 includes gaming openings 706, through which elements of mobile device 200 can be accessed. Gaming controller case 700 may also include an extended channel for gaming headphone channel 708.

First gaming case interface 702 (not shown) couples with expansion interface 302 (not shown) to enable any processing, caching, or wireless communication required by gaming controller case 700. Second gaming case interface 703 can draw power from an external source to keep both gaming case 700 and mobile device 200 through a marathon gaming session. Third gaming case interface 704 couples with mobile device electrical interface 204 to enable wired interaction between mobile device 200 and gaming controller case 700.

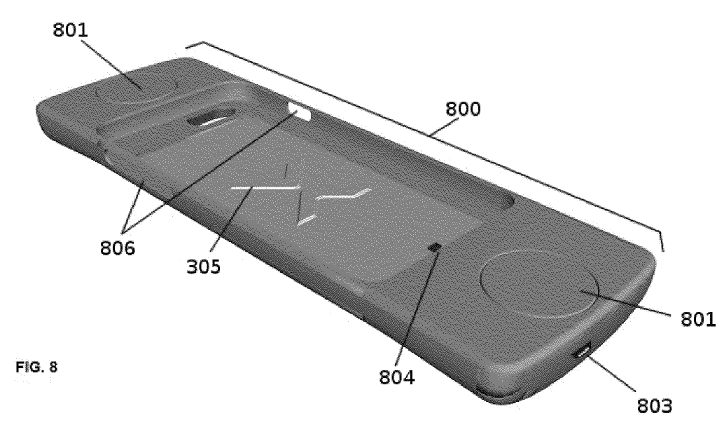

FIG. 8 illustrates the modular protective case expansion kit in a speaker configuration. The speaker configuration can use the same shell 100 and expansion platform 300, but in this embodiment, outer case 400 is replaced with a speaker case 800 configured to provide improved audio fidelity and higher volumes without negative distortion or artifacts.

Many users you their mobile devices 200 as their primary music storage and private listening device. Unfortunately most mobile devices 200 have extremely limited speakers. The device speakers are restricted to microscopic dimensions, which limits the range, response, volume, and bass that these device speakers can deliver. Many users try to use the device speakers for public listening, such as at a pool, a tailgate, or a party, but the tiny device speakers just weren't built for this kind of challenge. Other users purchase expensive mobile speaker systems for the sole purpose of playing music from mobile device 200 at a higher quality and volume, but this type of purchase is very costly and uses many redundant pieces such as the connector to the mobile device, the external power connectors, the processor, and the memory. All of these elements are already included in either expansion platform 300 or outer case 400. The speaker case 800 of FIG. 6 relies heavily on the processing power of expansion platform 400, but includes case speakers 801 that are a significant improvement over device speakers. The increased space for speakers allows for not only a single bigger speaker, but it could also enable an array of speakers to handle a variety of frequencies. Speaker case 800 can connect to mobile device 200 either through a wired connection or through wireless connection between the expansion platform 300 and mobile device 200.

First speaker case interface 802 (not shown) couples with expansion interface 302 (not shown) to enable any processing, caching, or wireless communication. Second speaker case interface 803 can draw power from an external source to keep both speaker case 800 and mobile device 200 as long as the party lasts. Third speaker case interface 804 couples with mobile device electrical interface 204 to enable hard-wired replay from mobile device 200. Speaker case 800 includes speaker openings 806, through which elements of mobile device 200 can be accessed. Though not shown in FIG. 8, speaker case 800 may also include an extended channel for speaker headphone channel 808 (not shown but similar in structure to gaming headphone channel 708 of FIG. 7).

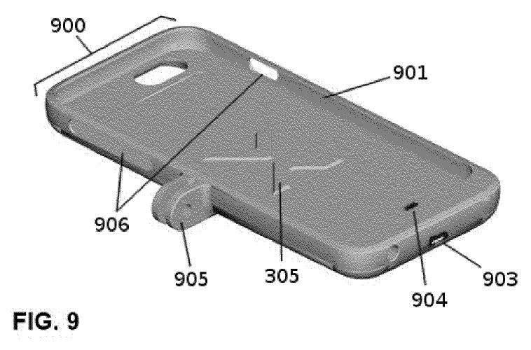

FIG. 9 illustrates the modular protective case expansion kit in an action camera configuration. The action camera configuration can use the same shell 100 and expansion platform 300, but in this embodiment, outer case 400 is replaced with an action case 900 specially configured to provide improved device protection, and can optionally include an additional lenses to provide panoramic or fish-eye view for certain activities.

Action cameras are used regularly in activities such as snowboarding, ziplining, and scuba diving. Often these cameras must be both waterproof and durable to survive the variety of rugged environments and impacts to which they are exposed during extreme sports activities. To match these elements, action case 900 provides very strong crush and impact protection to mobile device 200. Action camera sidewall 901 is comparatively stronger and more protective than sidewall 401. Although FIG. 9 shows an open-backed embodiment, action case 900 can include either open-backed or sealed waterproof configurations. In a sealed waterproof configuration, action camera case 900 would include a wall or membrane covering and protecting mobile device screen 201. Another embodiment of a waterproof action camera case 900 could include a gasket that can be compressed against mobile device screen 201 to create a watertight seal without restricting direct access to the touchscreen functionality. The open-air configuration can include action case openings 906 to avoid restricting In some configurations the sealed waterproof configuration would allow for manipulation of the touch screen on mobile device 200 through a screen membrane seal. Furthermore, action case 900 includes a universal mount adaptor 905 which can pair with common mounts, such as the mounts used by many popular action cameras or photography brands. Additionally, action case 900 can include a removable lens attachment 901 (not shown) that is both removable and swappable, so that a user has the option of using a panoramic lens, a fish-eye lens, or a zoom lens. Action case 900 includes action case openings 906, through which elements of mobile device 200 can be accessed.

First action case interface 802 (not shown) couples with expansion interface 302 (not shown) to enable any processing, caching, or wireless communication. Second action case interface 903 can draw power from an external source to keep both speaker case 800 and mobile device 200 as long as the party lasts. Third action case interface 904 couples with mobile device electrical interface 204 to enable hard-wired replay from mobile device 200.

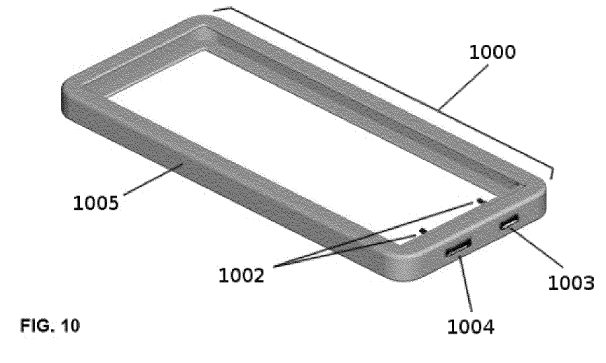

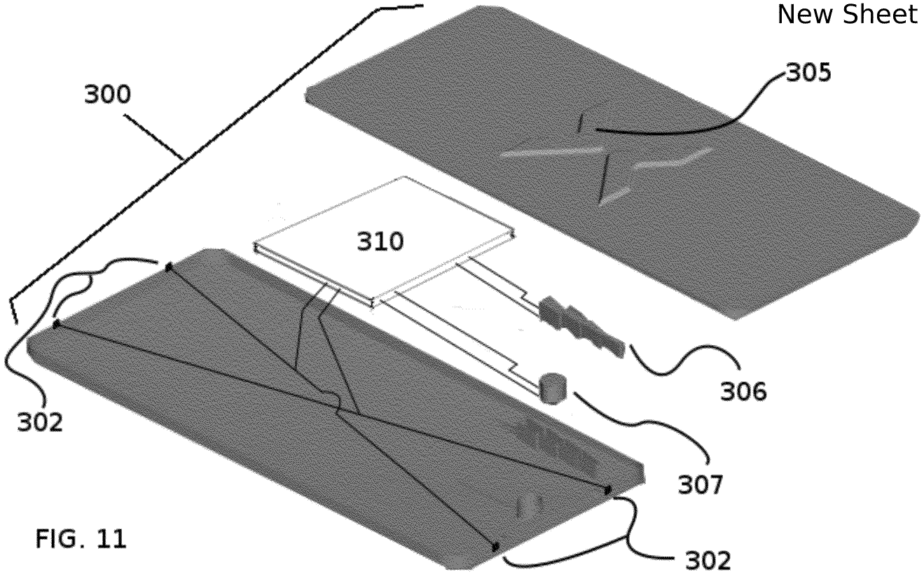

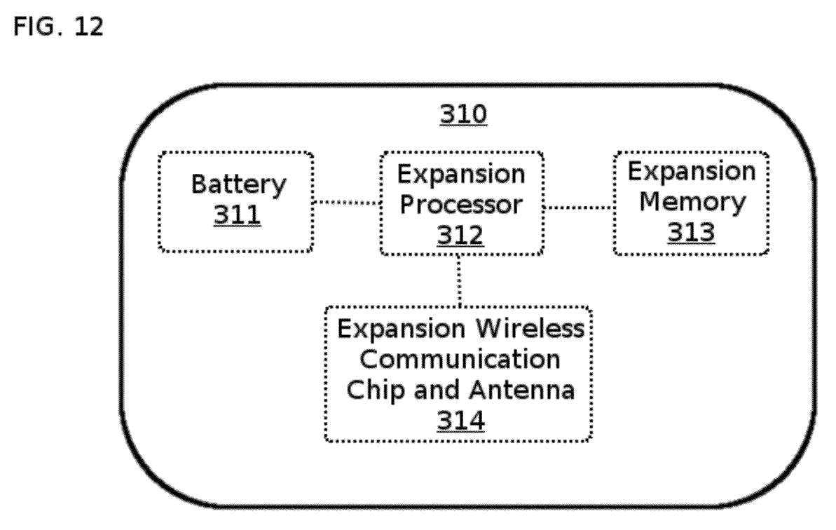

FIG. 10 illustrates the modular protective case expansion kit in universal battery bank configuration. The universal battery bank configuration involves connecting a universal adaptor 1000 to the expansion platform 300 to provide a standard connector 1001. Universal adaptor 1000 can draw power and provides other functionality from expansion platform 300 through first universal adaptor interface 1002 which connects to expansion interface 302. Additionally universal adaptor can accept outside charge or power through second universal adaptor interface 1003, which can then be passed to expansion platform 300. Universal adaptor body 1005 may be one or two pieces. In the one-piece configuration of FIG. 10, the body of universal adaptor 1000 may be made of a deformable material (e.g., rubber, silicon, elastic, etc.) that can be stretched around expansion platform 300. In an alternative two-piece embodiment, universal adaptor body 1005 may consist of two U-shaped elements that connect around and enclose expansion platform 300. In this configuration, expansion platform 300 can charge external devices such as music players, GPS units, external action cameras, fish-finders, or wearable computers through a third universal adaptor interface 1004, which can be any number of customized or standard connector types such as micro-USB or USB Type-C. Power and/or data could be transferred through any standard connection type, and the universal battery bank could boost or buck the voltage to match whatever standard is used. Indeed, the expansion platform could internally perform a boost or buck function to adjust the voltage for any of the previous configurations, although a boost/buck process could be included in any element of modular protective case. Alternatively universal adaptor 1000 may include one or more cables or dangles instead of connector 1001.

In another embodiment, the modular protective expansion kit could include a means for measuring weight or mass. A digital scale could be incorporated in either outer case 400 or expansion platform 300. The scale could be incorporated into the back of the device and could optionally include a separate display for the mass or weight. Alternatively a scale built into the device back could rest on its back while the weighed items would be placed on the phone screen or on some front portion of the modular protective expansion kit. The scale could use the phone display to display any measurement and also track historical measurements. The scale or the software associated with the scale could also have a zeroing function to calculate for and deduct the weight of the phone before any measurement is taken.

In another embodiment, the modular protective expansion kit could include a thermometer or barometer. Instead of relying on websites to display approximate temperatures or barometric pressure in an area, an incorporated meter could display exact results for the modular protective expansion kit's location. Either of these measuring tools could be incorporated into outer case 400 or expansion platform 300.

In another embodiment, the modular protective expansion kit could include a flashlight, a strobe light, an infrared light, or an ultra-violet light. These light sources could be used in place of or in conjunction with the camera flash, either for illuminating an area or for taking photographs. Any of these elements could be incorporated into outer case 400 or expansion platform 300.

In another embodiment, the modular protective expansion kit could include one or many light filters. Instead of relying on software to create visual effects, such as sepia or bluescale, an actual light filter could be used over the mobile device's camera lens to create more authentic filtered photographs. These one or many filters could be adjustable or removable, and the filters could be incorporated into outer case 400 or expansion platform 300.

In another embodiment, the modular protective expansion kit could include an IR emitter or IR blaster. With an IR attachment, the combination of mobile device 200 and modular protective expansion kit could fill many remote control functions, including as a universal remote control for a television, stereo system, or entertainment system, operating as a garage door opener or gate opener, replacing an electronic automobile key or security keyfob, or controlling remote control vehicles or devices. The IR emitted or IR blaster could be incorporated into outer case 400 or expansion platform 300, and the buttons could either be built into the modular protective expansion kit or displayed on mobile device 200.

In another embodiment, the modular protective expansion kit could include one or many biomedical monitoring or treatment kits. The biomedical kits a heart monitor, an EKG, a brain activity monitor, a TENS unit, or could include functionality for blood tests, glucose tests, insulin tests. Each biomedical kit could be incorporated into outer case 400, expansion platform 300, or could be a custom piece that attaches to and builds upon the functionality of either of the mentioned pieces. The biomedical kits could draw power from the expansion platform or from an outside power source.

In another embodiment, the modular protective expansion kit could include one or many industrial monitoring or solution kits. The industrial kits could include an infrared or thermal camera, a scanner, a mobile printer, a mobile 3d printer, or any other functional kit that would be useful for a particular industry. A small scanner could be used to quickly scan receipts or business cards into either expansion platform 200 memory or mobile device 200 memory. A small printer or 3d printer could allow users to print necessary papers or 3d models on the road without having to lug around bulky equipment. Each industrial kit could be incorporated into outer case 400, expansion platform 300, or could be a custom piece that attaches to and builds upon the functionality of either of the mentioned pieces. The industrial kits could draw power from the expansion platform or from an outside power source.

In another embodiment, the modular protective expansion kit could include virtual reality system that affixes mobile device to a user's body so that mobile device screen for a separate screen incorporated into modular expansion kit) fills a user's field of view. Using specific lenses and displaying a separate image to each user eye could convey a 3d view.

Additionally user head motion can be tracked to change perspective within a virtual world. Additional attachments could track hand or foot movement to allow user activity or motion within a virtual world.

In another embodiment, the modular protective expansion kit could incorporate non-electrical modules for user convenience. These non-electrical modules could include a folding compact mirror so that a user can quickly view himself on the go without carrying an additional separate mirror. The mirror could fold away when not in use. Additionally some modules could incorporate a case stand to hold up a mobile device during typing or movie viewing. Most mobile devices have to be held in the hand or lie flat when a user reads or watches a movie or video clip. By incorporating a case “kickstand”, the case could be propped up at an adjustable angle to optimize viewing angle while a user can use her hands for any other purpose. Another non-electric module embodiment could incorporate a ring or strap to wrap around a user's fingers, hands, or arm to secure a device so that it will not be dropped. A ring could slide around a user's finger and could rotate relative to the mobile device so that a user can securely hold a phone with one hand and change viewing angles without any risk of dropping the phone. Additionally a wrist-strap or arm-strap could be useful for monitoring exercise, for playing music, or for keeping information visible on a wrist while a user types into a keyboard.

Another non-electrical module could incorporate a screen protector into the shell or outer case. A screen protector could protect mobile device from a broken or scratched screen. The screen protector could be permanently affixed or attached by a hinge. Another hinged module might include a non-transparent screen cover. Another module might incorporate a credit card or ID card holder. Further, the combination of shell, expansion kit, and expansion platform could include a waterproof or water resistant option to protect the device around wet environments, such as the beach, by the pool, or during hikes. The waterproof or water resistant version could include tabs to plug any potential ingress points for electricity, and additional gaskets could be used to seal critical or vulnerable elements.

One or more of the features illustrated in FIGS. 1-10 may be rearranged and/or combined into a single component or embodied in several components. Additional components may also be added without departing from the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A modular expansion kit for a mobile device comprising:
a shell configured to receive and retain a mobile device, the shell comprising:
a shell back wall against which the mobile device rests;
a shell side wall attached to the edge of the shell back wall, the shell side wall conforming generally to the outer contours of the mobile device; and
at least one opening, through which a mobile device interface on the mobile device can be accessed;
an expansion unit configured to mechanically couple and decouple with the shell, the expansion unit comprising:
an expansion processor;
an energy storage element;
a button;
an LED; and
a first expansion interface electronically connected to the expansion processor and expansion energy storage element;
an outer case comprising:
a first outer case portion slidably engaging the expansion unit;
a second outer case portion slidably engaging the expansion unit;
a first outer case interface configured to electrically connect to the first expansion interface;
a second outer case interface configured to electrically connect to the mobile device electrical interface; and
wherein the first outer case portion is configured to couple to the second outer case portion, the first and second outer case portions together partially enclosing both the expansion unit and the shell; and
wherein the energy storage element and the processor are configured to electronically communicate with the mobile device through the outer case.

2. A modular expansion kit for a mobile device comprising:
a shell configured to receive and retain a mobile device, the mobile device comprising:
a mobile device body;
a mobile device screen;
at least one mobile device button;
a mobile device energy storage element;
a mobile device processor; and
a mobile device electrical interface;
an expansion unit configured to mechanically couple and decouple with the shell, the expansion unit comprising an at least one functional electronic element;
an outer case configured to mechanically couple and decouple with the expansion unit, the outer case generally enclosing the shell on at least 3 sides and electronically connecting with both the mobile device electrical interface and the functional electronic element.

3. The modular expansion kit of claim 2 wherein the mobile device body approximates a rectangular prism comprising 6 device surfaces and 8 device corners and the shell covers at least 3 device surfaces and all 8 device corners.

4. The modular expansion kit of claim 3 wherein the outer case covers at least 4 device surfaces and all 8 device corners.

5. The modular expansion kit of claim 2, wherein the mechanical coupling between the outer case and the expansion unit comprises:
a first outer case portion slidably engaging the expansion unit;
a second outer case portion slidably engaging the expansion unit;
wherein the first outer case portion is configured to couple with the second outer case portion, partially enclosing both the expansion unit and the shell; and
wherein the expansion unit and the shell can not be removed from the outer case while the first outer case portion is coupled to the second outer case portion.

6. The modular expansion kit of claim 5 wherein the outer case portion does not occlude either the mobile device screen or an external surface of the expansion unit.

7. The modular expansion kit of claim 2 further comprising:
wherein the expansion unit further comprises a first expansion interface electronically connected to the at least one functional electronic element;
wherein the outer case is configured to electronically connect to the functional electronic element of the expansion unit through a first outer case interface that connects to the first expansion interface;
wherein the outer case is configured to electronically connect to the mobile device electrical interface through a second outer case interface; and
wherein the mobile device is configured to electronically connect to the functional electronic element through the outer case.

8. The modular expansion kit of claim 7 wherein the expansion unit further comprises:
an expansion processor;
an expansion energy storage element;
an expansion input; and
an expansion charge indicator configured to indicate a charge level for the expansion energy storage element in response to an activation of the expansion input.

9. The modular kit of claim of claim 8 wherein the expansion energy storage element is a battery.

10. The modular expansion kit of claim 8 wherein the expansion energy storage element is configured to charge the mobile device battery when the first expansion interface is connected to the first outer case interface and the second outer case interface is connected to the mobile device interface.

11. The modular expansion kit of claim 8 wherein the expansion processor is configured to communicate with the mobile device processor when the first expansion interface is connected to the first outer case interface and the second outer case interface is connected to the mobile device interface.

12. The modular expansion kit of claim 2 wherein the shell comprises:
a shell back wall against which the mobile device body rests;
a shell side wall attached to the edge of the shell back wall, the shell side wall conforming generally to the outer contours of the mobile device body;
at least one opening, through which the mobile device interface can be accessed; and
wherein the shell does not occlude the mobile device screen.

13. The modular expansion kit of claim 12 wherein the expansion unit is physically in contact with the mobile device through a gap in the shell.

14. The modular expansion kit of claim 2 further comprising a plurality of inputs, including at least one directional pad or thumb-stick.

15. The modular expansion kit of claim 2 further comprising an infrared emitter.

16. The modular expansion kit of claim 2 further comprising a sensor capable of measuring weight or mass.

17. A modular expansion kit for a mobile device comprising:
an expansion unit comprising:
an expansion processor;
an expansion energy storage element;
an expansion input;
an expansion charge indicator; and
a first expansion interface electronically connected to the expansion processor and expansion energy storage element;
an outer case comprising:
a first outer case portion configured to slidably engage the expansion unit;
a second outer case portion configured to slidably engage the expansion unit;
a first outer case interface configured to electrically connect to the first expansion interface;
a second outer case interface configured to electronically connect to the mobile device electrical interface; and
wherein the first outer case portion is configured to couple to the second outer case portion, partially enclosing the expansion unit; and
wherein the energy storage element and the processor are configured to electronically connect to the mobile device through the outer case.

18. The modular expansion kit of claim 17 further comprising:
a shell configured to securely receive and retain a mobile device, the shell configured to couple and decouple with the expansion platform, the shell comprising:
a shell back wall against which the mobile device rests;
a shell side wall attached to the edge of the shell back wall, the shell side wall conforming generally to the outer contours of the mobile device; and
at least one opening, through which a mobile device interface on the mobile device can be accessed.

19. The modular expansion kit of claim 18 wherein the expansion unit is physically in contact with the mobile device through a gap in the shell.

20. The modular expansion kit of claim 18 further comprising an infrared emitter.
